(19) United States
(12) Patent Application Publication
(10) Pub. No.: US 2016/0364134 A1
(43) Pub. Date: Dec. 15, 2016

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventors: Xiuqin Wu, Beijing (CN); Lijun Wang, Beijing (CN)

(21) Appl. No.: 14/864,480

(22) Filed: Sep. 24, 2015

(30) Foreign Application Priority Data
Jun. 12, 2015 (CN) 201510324999.X
Jun. 12, 2015 (CN) 201510325670.5

(51) Int. Cl. G06F 3/0488; G06F 3/046; G06K 9/00; G06F 3/041; G06F 3/0481; G06F 17/24; G06F 3/0484

(52) U.S. Cl. CPC G06F 3/04883; G06F 17/24; G06F 3/046; G06F 3/0484; G06F 3/0412; G06F 3/0481; G06F 3/04845; G06K 9/00409; G06K 9/00422

(57) ABSTRACT

The present disclosure provides an information processing method and an electronic device. The information processing method, comprising: obtaining input traces, which are input by an operator, on an input area of an electronic device, the input area being not overlapped with a display area of a display screen of the electronic device; displaying the input traces on the display screen in real time; determining whether a trace complying with a predetermined rule is included in the input traces; and establishing a window corresponding to the trace complying with the predetermined rule when the trace complying with the predetermined rule is included in the input traces, the window being associated with an application. The above method provided by the present disclosure solves the technical problem with the conventional technical solutions that the processing mode for traces input by the user is generally unitary and inflexible, and cannot satisfy requirements of the user.

### CROSS-REFERENCE TO RELATED APPLICATION(S)

This application claims priority to the Chinese Patent Application No. 201510325670.5 filed on Jun. 12, 2015 entitled “INFORMATION PROCESSING METHOD AND ELECTRONIC DEVICE” and the Chinese Patent Application No. 201510324999.X filed on Jun. 12, 2015 entitled “INFORMATION PROCESSING METHOD AND ELECTRONIC DEVICE”, which are incorporated herein by reference in its entirety.

### TECHNICAL FIELD

The present disclosure relates to the field of electronic technique, and in particular, to an information processing method and an electronic device.

### BACKGROUND

With increasing development of science and technology, the electronic technology has been developed rapidly, and there are more and more types of electronic products, which enable people to enjoy various conveniences brought by the development of science and technology. Today, people may enjoy a comfortable life with the development of science and technology.

As an example of a conventional touch-control input apparatus, a touch-sensitive display screen of an electronic device may display user input traces on the display screen in real time, e.g. may display words, symbols or patterns etc. input by the user directly on the input screen in real time. However, the input traces displayed on the display screen are displayed in a fixed form, and thus the user cannot perform diversified processing on the displayed traces as required.

For another example of the conventional touch-control input apparatus, an electro-magnetic input screen of an electronic device may enable the user to input words, symbols or patterns etc. directly on the input screen. The traces input by the input screen are generally recognized based on an application currently running on the electronic device. For example, assuming that the currently running application is an word processing application, the traces input on an input area by handwriting of the user can be recognized as standardized Chinese characters. When the currently running application is the word processing application, if the user draws a table on the input area by hand, the table may be recognized by the electronic device as some words with similar shapes, or may be unrecognized.

### SUMMARY

A first aspect of the present disclosure provides an information processing method, comprising:

obtaining input traces, which are input by an operator, on an input area of an electronic device, the input area being not overlapped with a display area of a display screen of the electronic device;

displaying the input traces on the display screen in real time;

determining whether a trace complying with a predetermined rule is included in the input traces; and

establishing a window corresponding to the trace complying with the predetermined rule when the trace complying with the predetermined rule is included in the input traces, the window being associated with an application.

A second aspect of the present disclosure provides an electronic device, comprising:

a housing;

a display screen arranged on the housing;

an input apparatus arranged on a surface of the housing, an input area of the input apparatus being not overlapped with a display area of the display screen;

a storage arranged in the housing and configured to store program instructions;

at least one processor arranged in the housing, when the program instructions are executed on the at least one processor, the at least one processor being configured for:

obtaining input traces, which are input by an operator, on the input area of the input apparatus;

displaying the input traces on the display screen in real time;

determining whether a trace complying with a predetermined rule is included in the input traces; and

establishing a window corresponding to the trace complying with the predetermined rule when the trace complying with the predetermined rule is included in the input traces, the window being associated with an application.

### BRIEF DESCRIPTION OF THE DRAWINGS

In order to illustrate technical solutions according to embodiments of the present application clearly and completely, the embodiments will be described in detail with reference to the drawings. Obviously, the drawings as described below are only exemplary illustration of some embodiments of the present disclosure, but are not limitations to the present disclosure.

FIG. 1 is a flowchart of an information processing method according to a first embodiment of the present disclosure;

FIG. 2 is a schematic diagram of displayed user input traces in the information processing method according to the first embodiment of the present disclosure;

FIG. 3 is a flowchart of an implementation of step S103 in the information processing method according to the first embodiment of the present disclosure;

FIG. 4 is a schematic diagram of an example of input traces including a trace complying with a predetermined rule according to the first embodiment of the present disclosure;

FIG. 5 is a flowchart of an implementation of step S104 in the information processing method according to the first embodiment of the present disclosure;

FIG. 5A is a flowchart of an implementation of step S502 in FIG. 5;

FIG. 6 is a schematic diagram of an example of establishing a window matched with traces enclosed by a closed trace in step S503 of the information processing method according to the first embodiment of the present disclosure;

FIG. 7 is a schematic diagram of an example of operating editable display contents in the information processing method according to the first embodiment of the present disclosure;

FIG. 8 is a flowchart of another implementation of step S104 in the information processing method according to the first embodiment of the present disclosure;

FIG. 9 is a structure diagram of an electronic device according to a second embodiment of the present disclosure;

FIG. 10 is a schematic diagram of traces input by a user and a window established by the electronic device in the second embodiment of the present disclosure;

FIG. 11 is a schematic diagram of editing contents in a window by the user in the second embodiment of the present disclosure;

FIG. 12 is a structure diagram of an electronic device according to a third embodiment of the present disclosure;

FIG. 13 is a schematic diagram of an appearance of an electronic device according to a fourth embodiment of the present disclosure;

FIG. 14 is a flowchart of an information processing method in the fourth embodiment of the present disclosure;

FIG. 15A is a schematic diagram of input traces in the fourth embodiment of the present disclosure;

FIG. 15B is a schematic diagram of input contents in the fourth embodiment of the present disclosure;

FIG. 16A is another schematic diagram of input traces in the fourth embodiment of the present disclosure;

FIG. 16B is another schematic diagram of input contents in the fourth embodiment of the present disclosure;

FIG. 17A is yet another schematic diagram of input traces in the fourth embodiment of the present disclosure;

FIG. 17B is yet another schematic diagram of input contents in the fourth embodiment of the present disclosure;

FIG. 18 is a schematic diagram of input traces obtained by an electro-magnetic input screen and input contents displayed by a display screen in the fourth embodiment of the present disclosure;

FIG. 19 is another schematic diagram of input traces obtained by an electro-magnetic input screen and input contents displayed by a display screen in the fourth embodiment of the present disclosure;

FIG. 20 is a structure diagram of an electronic device according to a fifth embodiment of the present disclosure; and

FIG. 21 is a structure diagram of an electronic device according to a sixth embodiment of the present disclosure.

### DETAILED DESCRIPTION

An information processing method and an electronic device provided by embodiments of the present disclosure intend to solve the technical problem with the conventional technical solutions that the processing mode for traces input by the user is generally unitary and inflexible, and cannot satisfy requirements of the user.

In order to solve the above technical problem, the embodiments of the present disclosure provide an information processing method, a general principle thereof is as follows:

obtaining input traces, which are input by an operator, on an input area of an electronic device, the input area being not overlapped with a display area of a display screen of the electronic device;

displaying the input traces on the display screen in real time;

determining whether a trace complying with a predetermined rule is included in the input traces; and

establishing a window corresponding to the trace complying with the predetermined rule when the trace complying with the predetermined rule is included in the input traces, the window being associated with an application.

According to the technical solution in the embodiments of the present disclosure, the input traces may be divided by the trace complying with the predetermined rule, and different parts of the input traces are associated with different windows and applications. Thus, the different parts of the input traces may be recognized as input contents supported by respective applications. As such, when the user needs to edit input contents, the input contents may be processed by the electronic device in accordance with respective editable manners of respective applications. That is, the technical solutions according to the embodiments of the present disclosure may satisfy the diversified requirements of the user on editing the input traces. Therefore, the technical problem with the conventional technical solutions that the processing mode for traces input by the user is generally unitary and inflexible and cannot satisfy requirements of the user may be solved.

Hereinafter, the general principle, particular implementations and beneficial effects of the technical solutions according to the embodiments of the present disclosure will be described in detail in connection with the drawings.

### First Embodiment

In a particular implementation, the information processing method may be applied in an electronic device. The electronic device may be an electronic device with a display screen, such as a mobile phone, a tablet computer, a notebook and the like, and may also be other possible electronic device, which will not be enumerated here.

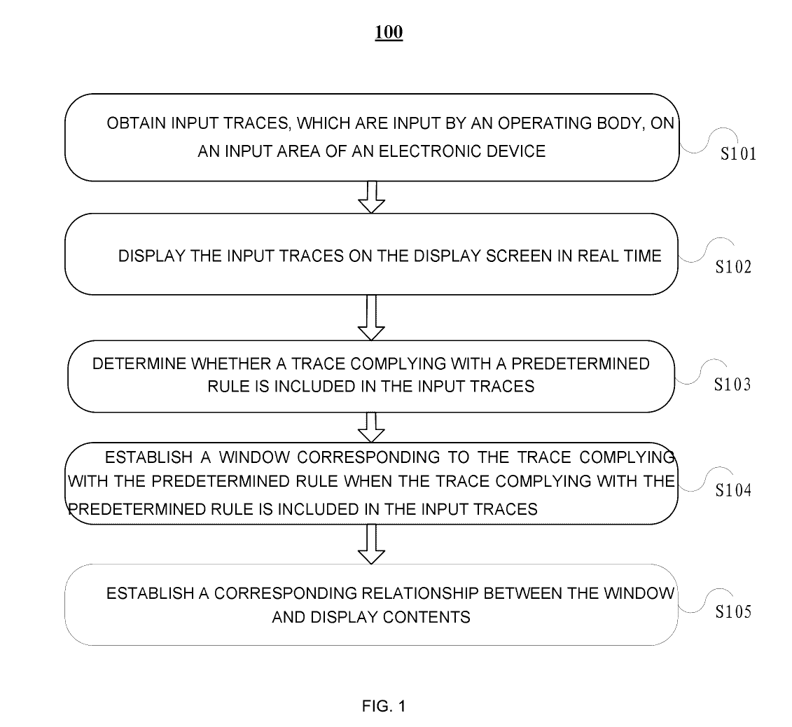

With reference to FIG. 1, the first embodiment of the present disclosure provides an information processing method 100, comprising:

step S101 of obtaining input traces, which are input by an operator, on an input area of an electronic device, the input area being not overlapped with a display area of a display screen of the electronic device;

step S102 of displaying the input traces on the display screen in real time;

step S103 of determining whether a trace complying with a predetermined rule is included in the input traces; and

step S104 of establishing a window corresponding to the trace complying with the predetermined rule when the trace complying with the predetermined rule is included in the input traces, the window being associated with an application.

Optionally, the information processing method 100 may further comprise step S105 of establishing a corresponding relationship between the window and display contents on the display screen which correspond to the trace complying with the predetermined rule.

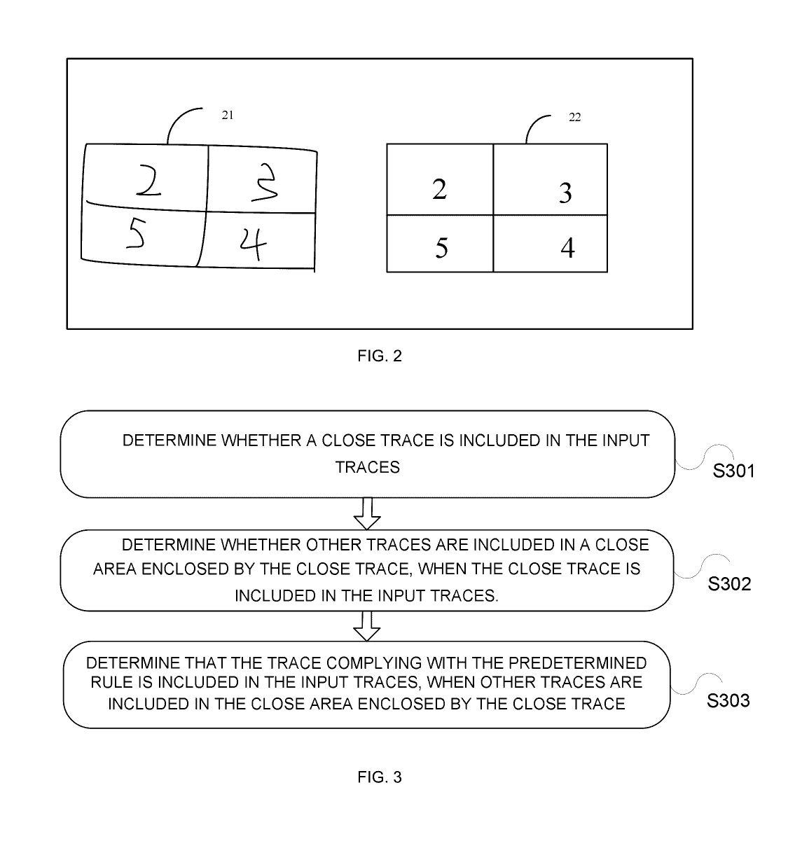

Particularly, in the present embodiment, the input area of the electronic device may be an area corresponding to an input screen such as a touch-sensitive screen or an electro-magnetic screen. The user may input, on the input screen, input traces to be displayed. For example, the user may draw a picture, or write a word and the like on the touch-sensitive screen. When the electronic device detects the input traces of the user on the input screen, the traces are displayed on the display screen in real time. In a particular implementation, the electronic device may directly display the input traces e.g. as a image on the display screen, or may convert the traces input by the user into contents in a standard format and display the contents in the standard format on the display screen. That is, the display contents may be the original traces input by the user, or may be contents converted from the input traces. As shown in FIG. 2, when the user inputs a table in the input area, the electronic device may display the input table (which is labeled as “21”) in its original traces on the display screen, or may convert the table input by the user into a standard table 22 and display the standard table 22 on the display screen. In a particular implementation, the format of the display contents may be determined according to actual requirements, which is not limited by the present disclosure.

The traces input by the user may comprise traces complying with a predetermined rule for triggering to establish a window and traces for representing actual input contents.

Then, the electronic device determines whether a trace complying with the predetermined rule is included in the traces input by the user on the input screen. For example, the electronic device determines whether a trace with a specific shape is included in the input traces. When the electronic device determines that a trace complying with the predetermined rule is included in the input traces, the electronic device may determine to establish a window corresponding to the trace complying with the predetermined rule, and to establish a corresponding relationship between the display contents on the display screen corresponding to the trace complying with the predetermined rule and the established window, i.e., to enable the display contents corresponding to the trace complying with the predetermined rule to support an edit format corresponding to the application associated with the window. Then, when the user needs to edit the display contents corresponding to the trace complying with the predetermined rule, the electronic device may process the display contents corresponding to the trace complying with the predetermined rule according to the edit format of the application. Therefore, the technical problem with the conventional technical solutions that the processing mode for traces input by the user is generally unitary and inflexible and cannot satisfy requirements of the user may be solved, and diversified requirements of the user on editing the input traces may be satisfied.

In a preferred implementation, the trace complying with the predetermined rule is a closed trace enclosing other traces. In this implementation, step S103 of determining whether the trace complying with the predetermined rule is included in the input traces may be particularly implemented by a method as shown in FIG. 3.

In step S301, it is determined whether a closed trace is included in the input traces.

In step S302, it is determined whether other traces are included in a closed area enclosed by the closed trace, in case that the closed trace is included in the input traces.

In step S303, it is determined that the trace complying with the predetermined rule is included in the input traces, in case that the determination result of step S302 indicates the other traces are included in the closed area enclosed by the closed trace.

If the determination result of step S301 is that no closed trace is included in the input traces, or the determination result of step S302 is that no other traces are included in the closed area enclosed by the closed trace, it is determined that the trace complying with the predetermined rule is not included in the input traces.

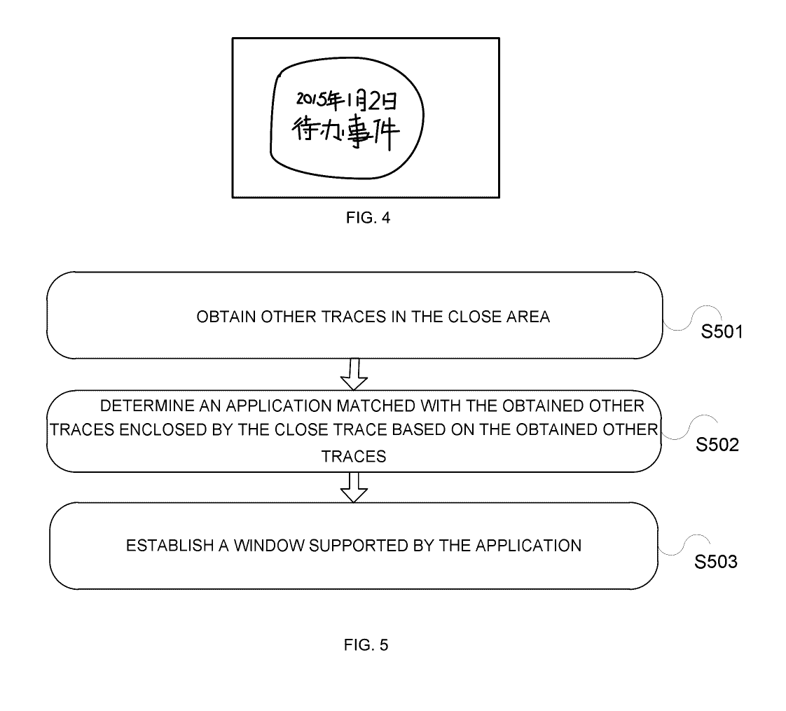

Particularly, in the present embodiment, when the electronic device detects a traces input by the user on the input screen, the electronic device identifies the input traces, and determines whether a closed trace is included in the input traces. When it is determined that a closed trace is included in the input traces, it is further determined whether any other traces are included in the closed area enclosed by the closed trace. When it is determined that the closed area enclosed by the closed trace contains any other traces input by the user, the electronic device determines that a trace complying with a predetermined rule is included in the input traces. In this case, the electronic device is triggered to establish a window. As shown in FIG. 4, in case that the user writes some words down in a first area of the input screen, and then circles these words by a closed trace, the electronic device may display the traces input by the user on the display screen, and the electronic device detects that a closed trace is included in the traces input by the user, and that words are contained within the closed trace, thereby determining that a trace complying with the predetermined rule is included in the input traces and further determining that the traces input by the user satisfies a condition of triggering the electronic device to establish a window. Thus, the electronic device is triggered to establish a window only if the closed trace is included in the traces input by the user and there is other traces within the closed area enclosed by the closed trace. Therefore, misoperations of the user that could cause the electronic device to establish a window the user does not hope to establish may be avoided, so that the approach of establishing the window may better satisfy the requirements of the user.

When the electronic device determines that a closed trace is included in the input traces, but the closed area enclosed by the closed trace does not include other traces, the electronic device determines that the closed trace is not a trace complying with the predetermined rule, but represents traces of actual input contents.

Particularly, in the present embodiment, when the electronic device determines that no other traces are included in the closed area enclosed by the closed trace, it may be determined that the closed trace is not input by the user for establishing a window, but only represents traces of actual input contents, which are traces needed to be displayed on the display screen. For example, when the user draws a circle in a second area of the input screen, the user does not mean to establish a window, but intends to let the electronic device display the circle on the display screen. In this case, although the electronic device detects that a closed trace (i.e., the circle) is included in the traces input by the user, it may be determined that a trace complying with a predetermined rule is not included in the input traces, since no other traces are included in the circle. Then, it may be further determined that the traces input by the user does not satisfy the condition of triggering the electronic device to establish a window.

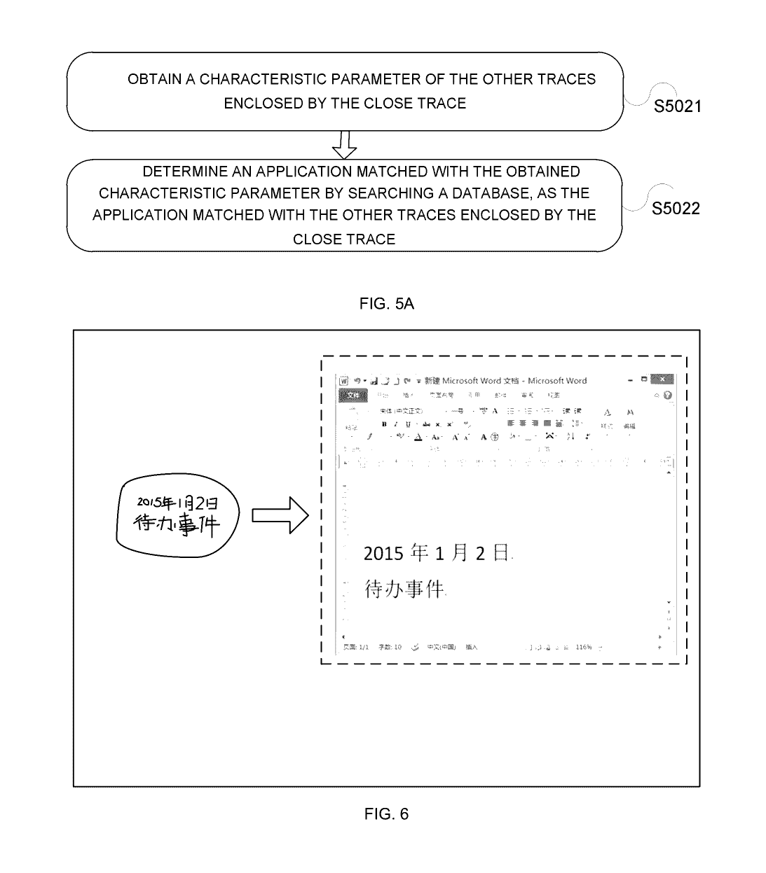

When the information processing method according to the present embodiment is performed, step S104 of establishing a window corresponding to the trace complying with the predetermined rule when the trace complying with the predetermined rule is included in the input traces may be particularly implemented by the method as shown in FIG. 5.

In step S501, other traces in the closed area enclosed by the closed trace are obtained.

In step S502, an application matched with the obtained other traces enclosed by the closed trace is determined, based on the obtained other traces in the closed area enclosed by the closed trace.

In step S503, a window supported by the application is established as the window corresponding to the trace complying with the predetermined rule.

Particularly, in the present embodiment, the electronic device determines that the trace complying with the predetermined rule is included in the input traces, i.e., there is a closed trace in the traces input by the user, and other traces are included in the closed trace. The electronic device obtains and identifies other traces in the closed area enclosed by the closed trace, determines the application matched with the other traces, and then establishes an window supported by the application. For example, when the electronic device identifies that the traces enclosed by the closed trace are contents representive of words, a WORD application may be determined as the application matched with the word contents, and thus a window of the WORD application may be established; when the electronic device identifies that the traces enclosed by the closed trace are contents representive of a table, an EXCEL table application may be determined as the application matched with the table content, and thus a window of the EXCEL table application may be established; when the electronic device identifies that the traces enclosed by the closed trace are contents representive of image, a drawing application may be obtained as the application matched with the image content. As shown in FIG. 6, when the traces input by the user is some words and includes a closed trace circling these words, the electronic device identifies that the contents in the closed area enclosed by the closed trace are contents representive of words, and thus obtains the WORD application as the application matched with the word contents and establishes a window of the WORD application. Then, The words are input in the window of the WORD application in a format supported by the WORD application.

Particularly, step S502 of determining the application matched with the obtained other traces enclosed by the closed trace based on the obtained other traces in the closed area enclosed by the closed trace may be implemented by the method as shown in FIG. 5A.

In step S5021, a characteristic parameter of the other traces enclosed by the closed trace is obtained.

In step S5022, an application matched with the obtained characteristic parameter is searched in a database, wherein the database comprises matching parameters of at least two applications. If the application matched with the obtained characteristic parameter is found in the database, the application may be considered as the application matched with the other traces enclosed by the closed trace,

Specifically, at the time when or before the method 100 of the present disclosure is performed, the electronic device may run one or more applications, or may not run any application, which may be set by the skilled in the art according to actual requirements, and may not limited by the present disclosure.

The matching parameters of at least two applications are stored in the database. The matching parameters of the application may be parameters of an input object which may be identified by the application. For example, the matching parameters of an word processing application may be a Chinese word matching parameter, an English word matching parameter etc., and the matching parameters of an electronic table application may be a number matching parameter, a table matching parameter etc.

In the embodiments of the present disclosure, the characteristic parameters of the input traces may comprise, but not limited to, a start point, an end point, an inflection point, a writing order and a trace outline etc. of the input traces. Then, the application matched with the characteristic parameters of the input traces may be determined by matching the characteristic parameters of the input traces with the matching parameters of at least two applications in the database.

Hereinafter, the matching process in step S5022 will be illustrated by several examples as follows.

In a first example, it is assumed that the input traces are displayed as shown in FIG. 15A. The characteristic parameters of the input traces extracted by the electronic device are an outline, 4 inflection points and 12 cross points of the input traces. And it is assumed that the matching parameters of the electronic table application include: a degree of approximation between the outline and a rectangle being higher than 85%, 4 inflection points, and all of cross points being located on a horizontal line and a vertical line or an approximately horizontal line and an approximately vertical line. By comparison, the electronic device may determine that the outline of the input traces in FIG. 15A is approximate to a rectangle, and the degree of approximation is 90%; there are 4 inflection points; and every 3 cross points, among 12 cross points, are located on an approximately horizontal line. Further, the electronic device may determine that the characteristic parameters are matched with the matching parameters of an electronic table application, and thus the application corresponding to the input traces are the electronic table application.

In a second example, it is assumed that the input traces are displayed as shown in FIG. 16A. The characteristic parameters of the input traces extracted by the electronic device are an outline of a plurality of linear traces, and 3 cross points. And it is assumed that the matching parameters of the electronic table application include: an approximately horizontal line, and an end point of the approximately horizontal line and two oblique lines constituting an arrow; an approximately vertical line, and an end point of the approximately vertical line and two oblique lines constituting an arrow; the approximately horizontal line and the approximately vertical line having one and only one cross point. By comparison, the electronic device may determine that the input traces in FIG. 16A has an approximately horizontal line, an approximately vertical line, and there is only one cross point between the two lines; and also, the end point of each of the two lines constitutes an arrow together with two oblique lines. Therefore, the electronic device may determine that the characteristic parameters are matched with the matching parameters of an electronic table application, and thus the application corresponding to the input traces are the electronic table application.

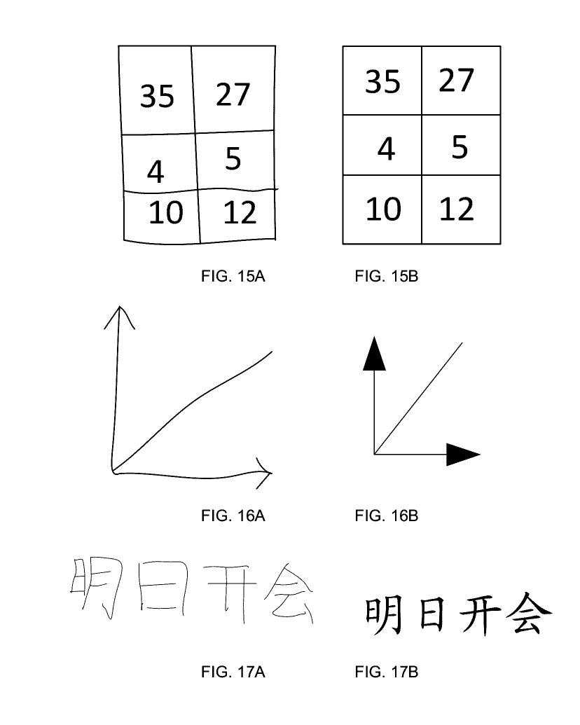

In a third example, it is assumed that the input traces are displayed as shown in FIG. 17A. The characteristic parameters of the input traces extracted by the electronic device are an outline, and cross points of the input traces. The electronic device may determine that the characteristic parameters are matched with the Chinese word parameters by comparing the characteristic parameters with the matching parameters in the database. Therefore, the electronic device may determine that the characteristic parameters are matched with the matching parameters of an word processing application, and thus the application corresponding to the input traces are the word processing application.

It should be understood that the above examples are described for illustration, but are not for limitation.

After the application matched with the other traces enclosed by the closed trace are determined, step S503 may be performed, i.e., establishing the window supported by the application. The established can be considered as the window corresponding to the trace complying with the predetermined rule. Particularly, in step S503, the other traces enclosed by the closed trace may be converted, based on the application, into the content which can be recognized by the application. Thus, an irregular input traces may be recognized as input contents which are standardized and can be recognized by the application.

In particular, the conversion of the input traces by the application may be performed according to the contents which are recognizable by the application. For example, the electronic table application can recognize a table, a number, a coordinate chart, then the input contents into which the electronic table is converted may be combinations of one or more of table, number or coordinate chart.

With reference to the three examples as previously discussed, in the first example, the electronic table application may convert the 4 approximately horizontal lines in the input traces as shown in FIG. 15A into horizontal lines, convert the 3 approximately vertical lines into vertical lines, and thus convert the outline of the input traces from an approximate rectangle into a rectangle. Further, the numbers in the table which are written by hand are converted into standard Arabic numbers. After the conversion, input contents may be obtained as shown in FIG. 15B.

In the second example, the electronic table application may convert the approximately horizontal line in the input traces as shown in FIG. 16A into a horizontal line, and convert the arrow constituted by the end point of the approximately horizontal line and the two oblique lines into a standard arrow; convert the approximately vertical line into a vertical line, and convert the arrow constituted by the end point of the approximately vertical line and the two oblique lines into a standard arrow; and convert a function image in the coordinate chart from the approximate straight lines into straight lines. Finally, input contents as shown in FIG. 16B is obtained.

In the third example, the handwriting input method may convert the 4 Chinese words written by hand into standard Chinese words to obtain input contents as shown in FIG. 17B.

After the application converts the other traces enclosed by the corresponding closed trace into the content which are recognizable by the application, the method 100 may further comprise: displaying, on the display screen, the converted input contents (e.g. the input contents with a regular format) to replace a corresponding part of the input traces displayed in real time, in order to facilitate the user's viewing. Further, the electronic device may save the input contents, or may automatically add the input contents to the desktop etc., which are not particularly limited by the present disclosure.

After the window corresponding to the trace complying with the predetermined rule is established, the corresponding relationship between the window as well as the associated application thereof and the display contents on the display screen which correspond to the trace complying with the predetermined rule may be established, so that the display contents, displayed on the display screen, which correspond to the trace complying with the predetermined rule are editable contents.

Particularly in the present embodiment, after the electronic device establishes the window corresponding to the trace complying with the predetermined rule, the display contents corresponding to the trace complying with the predetermined rule is bound to the application associated with the window, and the display contents corresponding to the trace complying with the predetermined rule is converted into the input contents which can be recognized by the application to be input in the established window. For example, when the display contents corresponding to the trace complying with the predetermined rule is table content, the application establishes a window supported by the EXCEL table application, then converts the display contents corresponding to the trace complying with the predetermined rule into the input contents which can be recognized by the EXCEL table application.

Further in the embodiments of the present disclosure, after the corresponding relationship between the window and the display contents on the display screen which is corresponding to the trace complying with the predetermined rule is established, the display contents become editable. Then, the method 100 may further comprises:

obtaining an user operation on the display contents;

determining an edit instruction corresponding to the user operation; and

performing corresponding editing on the display contents according to the edit instruction.

In particular, the electronic device may obtain a specific operation on the display contents of the operator via the input area of the input apparatus (such as the touch-sensitive screen or the electro-magnetic input screen). Specifically in the embodiments of the present disclosure, the specific operation is associated with the edit instruction supported by the application. For example, the specific operation may be clicking a plurality of numbers in the table, and then the corresponding edit instruction may be an automatic summation; the specific operation may be sliding from the first table on some row or some column to the last table on that row or that column, and then the corresponding edit instruction may be ranking, which may be set by the skilled in the art according to actual requirements, and are not limited by the present disclosure. The corresponding relationship between a specific operation and its corresponding edit instruction may be informed to the user in advance by e.g. a user manual or help etc., so as to be known by the user.

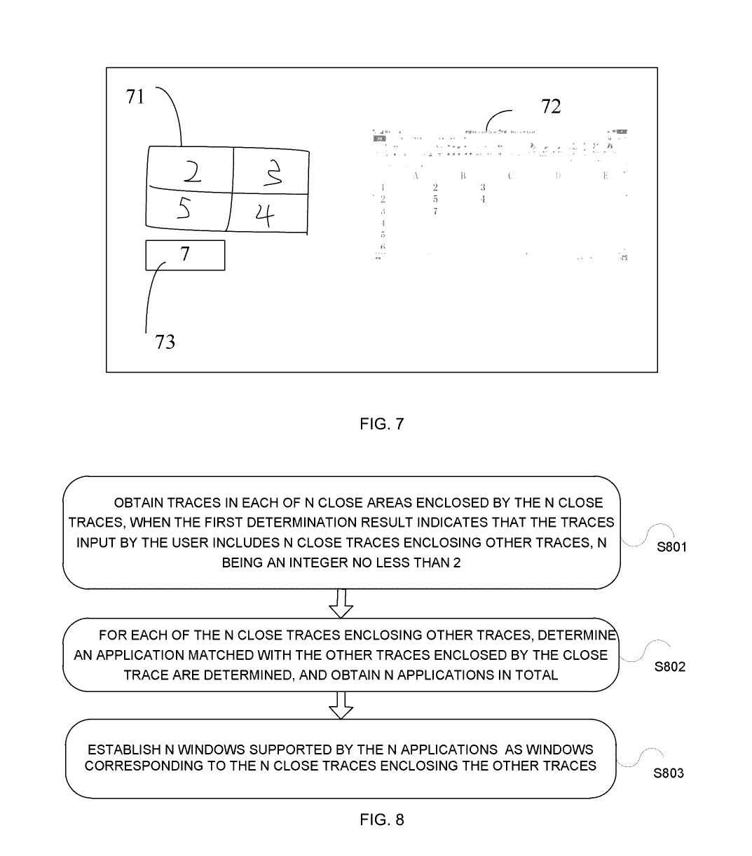

After the user performs the specific operation by the operator, the electronic device may determine the edit instruction corresponding to the specific operation, so that the display contents may be edited accordingly. As shown in FIG. 7, the user draws a table 71 with two rows and two columns in the input area, in which a number 2 is filled in the first row and the first column, a number 5 is filled in the second row and the first column, a number 3 is filled in the first row and the second column, and a number 4 is filled in the second row and the second column. According to the method of the present disclosure, the electronic device establishes an EXCEL table document 72, and input the recognized numbers to the EXCEL table document. When the user selects the number 2 in the first row and the first column and the number 5 in the second row and the first column of the table drawn by the user on the display screen, and clicks a lower right corner of the selected box to drag down, it means that the user needs to perform a summation processing on the number 2 in the first row and the first column and the number 5 in the second row and the first column. Therefore, the operations may be performed in mirrow on the EXCEL table document established by the electronic device, summing the number 2 in the first row and the first column and the number 5 in the second row and the first column of the EXCEL table document to obtain a summation result of 7. The output result 73 is displayed below the second row and first column of the table drawn by the user. The newly established EXCEL table document may be established by the electronic device in background, and the established EXCEL table document 72 may be displayed beside the table drawn by the user, so that the user may edit more intuitively. By doing this, the edit processing of the user on the input traces may be implemented, and the requirements of the user may be satisfied better.

In some implementations, since the user may input various types of traces in the input area, the electronic device may establish windows supported by different applications corresponding to different content accordingly. Thus, step S104 may comprise: establishing N windows respectively corresponding to N trace complying with the predetermined rule when the N traces complying with the predetermined rule are included in the input traces, N being an integer no less than 2.

Hereinafter, a preferred implementation of step S104 will be described in detail with reference to FIG. 8.

In step S801, when it is determined that the traces input by the user includes N closed traces enclosing other traces, traces in each of N closed areas enclosed by the N closed traces are obtained, N being an integer no less than 2.

In step S802, for each of the N closed traces enclosing other traces, an application matched with the other traces enclosed by the closed trace are determined, and N applications are obtained in total.

In step S803, N windows supported by the N applications are established as windows corresponding to the N closed traces enclosing the other traces.

Particularly, in the present embodiment, when the electronic device determines that the trace complying with the predetermined rule (e.g., the closed trace enclosing other traces) are included in the input traces, it is determined that the electronic device needs to establish N windows. The approach of establishing the windows comprises: identifying respective contents in respective closed areas enclosed by the respective closed traces, and obtaining respective applications matched with the respective contents, then establishing respective windows supported by the respective applications, and converting the contents in the respective closed areas enclosed by the respective closed traces into respective input contents which can be recognized by the respective applications. That is, when there are N closed traces, N windows are established, each of the N windows being bound to one application respectively, and the contents in the closed area enclosed by each of the N closed traces also being bound to the application corresponding to the window. For example, the user inputs some words at the upper left corner of the input area, and inputs a closed trace to circle these words. The user draws a table at the lower right corner of the input area, and inputs a closed trace to circle the table. Further, the electronic device determines that two windows needs to be established, in which a first window is a window supported by a wordpad application, and these words input by the user in the input area are converted into contents which can be recognized by the wordpad; and a second window established by the electronic device is a window supported by an EXCEL table application, and the table input by the user in the input area is converted into content which can be recognized by the EXCEL table application.

By doing this, when the traces input by the user comprise a plurality of closed traces, and display contents is contained in each of the closed traces, the windows supported by different applications corresponding to different display contents may be established, and various display contents may be bound to the corresponding applications. Thus, different edit requirements of the user on different display contents may be guaranteed.

Further, since corresponding relationships between N windows and N contents are established, the display contents corresponding to each window are editable contents. Therefore, after the corresponding relationships between the N windows and the N contents are established, the method may further comprises:

determining whether there is an operation of copying a display content which is displayed in a first one of the N windows; and if so, copying and pasting the display content to a second one of the N windows which is different from the first window and is selected by the user.

Particularly in the present embodiment, the electronic device establishes the corresponding relationship between the N windows and the N number of second contents, the display contents corresponding to each window being editable content. When the electronic device detects the operation of copying the display sub-content displayed in the first window, the selected content may be converted in a format which can be recognized by the application, that corresponds to the input traces, corresponding to the first window, and the converted content may be saved to the wordpad. When the user performs a paste operation in the second window, the converted content may be directly displayed in the second window; or the converted content may be further converted in a format which can be recognized by a second application that corresponds to the second window, and thus the further converted content may be displayed in the second window. By doing this, the user may edit, such as copy, paste etc., the input traces. Of course, other edit approaches of the user on the input traces are also possible, which are not limited by the present disclosure.

### Second Embodiment

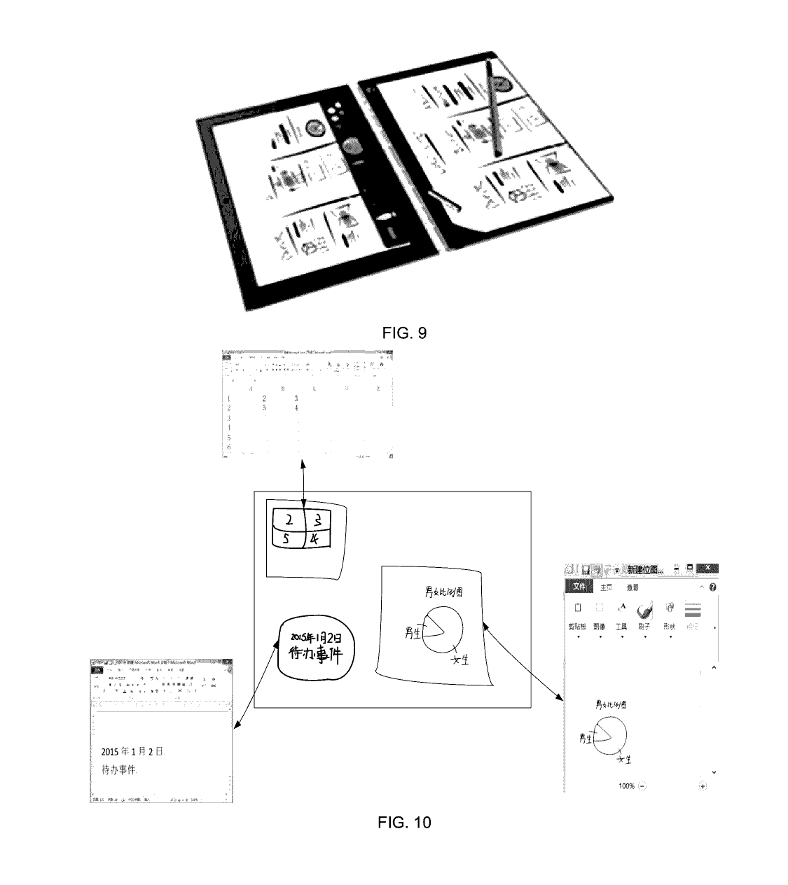

In order that the skilled in the art can understand a particular implementation of the information processing method introduced in the first embodiment of the present application, the information processing method 100 is particularly applied in the present embodiment to a particular implementation of an electronic device. As shown in FIG. 9, the electronic device comprises an electro-magnetic handwriting screen 91 provided with an electro-magnetic pen 92, a piece of paper being placed on the electro-magnetic handwriting screen 91. When the user inputs traces on the paper placed on the electro-magnetic handwriting screen 91 by the electro-magnetic pen 92, the traces can be displayed on a display screen 93 of the electronic device in real time. The display screen 93 is a touch-control display screen, and may respond to a touch-control operation of the user.

In the present embodiment, when the user inputs the traces on the paper placed on the electro-magnetic handwriting screen 91 by the electro-magnetic pen 92, the electro-magnetic handwriting screen 91 may detect the traces input by the electro-magnetic pen 92, and display the traces on the display screen in real time. As shown in FIG. 10, the user draws a table in a first area on the paper, draws a pie chart with words in a second area, and writes some words in a third area. And after the content has been input by the user, the user selects the words, the table and the pie chart with closed traces. The electronic device recognizes that there are three parts of traces in the traces input by the user satisfy the predetermined rule. Thus, the electronic device determines that three windows are required to be established. Further, the electronic device recognizes that the content in the closed area enclosed by the closed trace in the first area is table content, and thus the electronic device establishes an EXCEL table window, recognizes the number in the table input by the user, and inputs the number in the table to the established EXCEL table application in a format that can be recognized by the EXCEL table application. The electronic device recognizes that the content in the closed area enclosed by the closed trace in the second area is an image, and thus the electronic device establishes a drawing window, and inputs the drawn pattern to the drawing window in a format that can be recognized by the drawing application. The electronic device recognizes that the content in the closed area enclosed by the closed trace in the third area is word content, and thus the electronic device establishes a WORD window, converts the words input by the user into a format that can be recognized by the WORD application, and inputs the converted words to the WORD window.

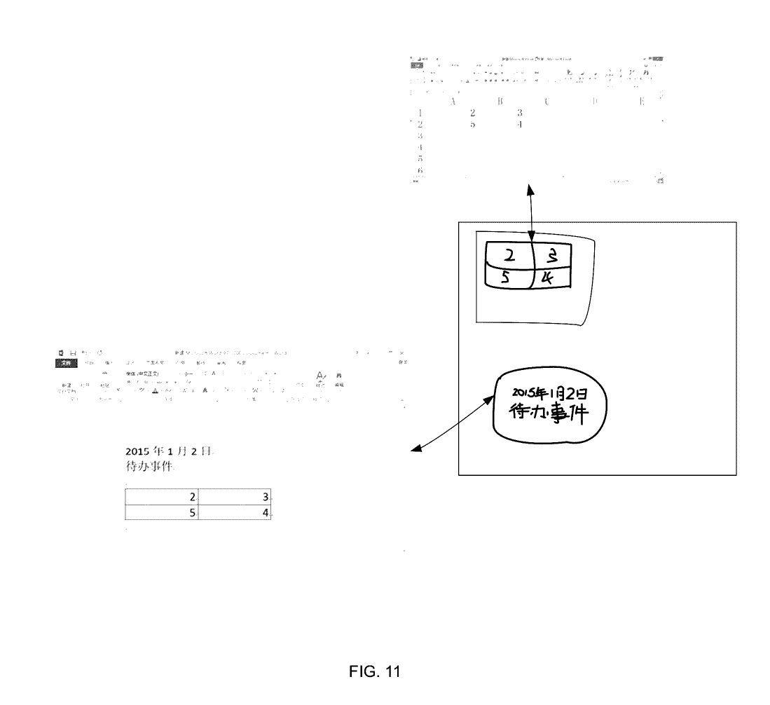

After the three windows are established and corresponding content are input to the corresponding windows in corresponding formats, the traces input by the user can be converted into editable content. For example, when the user selects the table displayed in the first area of the display screen, particularly, when the user may press the table on the display screen for a long time or click several times on the table, the electronic device determines that the selected user operation is an operation of selecting the table, and thus the electronic device selects the content in the established EXCEL table. After it is determined that the table is selected, the electronic device pops-up a prompt box in the area where the user presses or clicks, prompting the user to select an operation item in the prompt box, e.g., “Copy”, “Search”, “Cut” etc. When the user selects “Copy”, the content in the EXCEL table established by the electronic device is copied to the wordpad. After the copy operation, the electronic device may respond to the paste operation of the user. In particular, the user may paste the copied table to the WORD window established by the electronic device. For example, the user presses a blank area in the closed trace on the display screen corresponding to the words for a long time; the electronic device pops-up a prompt box in the area where the user presses, prompting whether the user performs the paste operation; when the user determines to paste, the table in the wordpad is copied to the WORD window established by the electronic device, as shown in FIG. 11.

### Third Embodiment

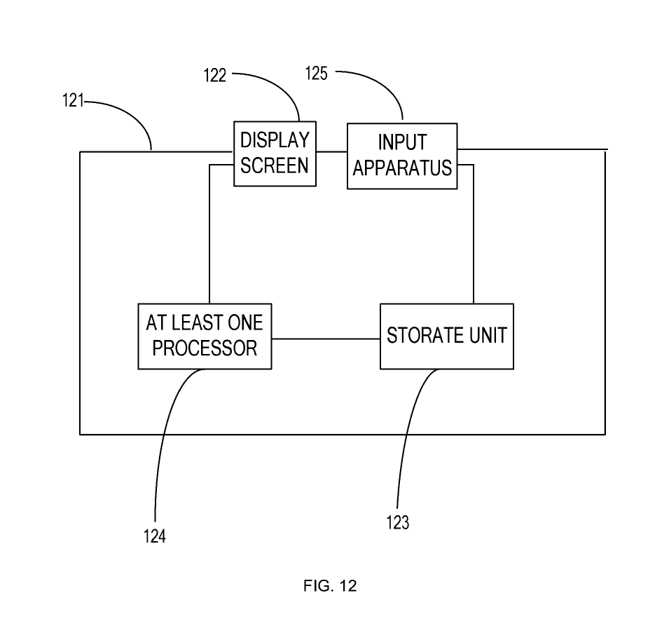

With reference to FIG. 12, an embodiment of the present disclosure further provides an electronic device, which comprises:

a housing 121;

a display screen 122 arranged on the housing;

an input apparatus 125 arranged on a surface of the housing, an input area of the input apparatus being not overlapped with a display area of the display screen;

a storage unit 123 arranged in the housing and configured to store program instructions;

at least one processor 124 arranged in the housing, when the program instructions are executed on the at least one processor, the at least one processor being configured to: obtaining input traces, which are input by an operator, on the input area of the input apparatus; displaying the input traces on the display screen in real time; determining whether a trace complying with a predetermined rule is included in the input traces; and establishing a window corresponding to the trace complying with the predetermined rule when the trace complying with the predetermined rule is included in the input traces, the window being associated with an application.

In some implementations, the trace complying with the predetermined rule may be a closed trace enclosing other traces.

In some implementations, the at least one processor is configured to establish the window corresponding to the trace complying with the predetermined rule by:

determining an application matched with the other traces enclosed by the closed trace; and establishing a window supported by the application as the window corresponding to the trace complying with the predetermined rule.

In some implementations, the at least one processor is configured to determine the application matched with the other traces enclosed by the closed trace by:

obtaining a characteristic parameter of the other traces enclosed by the closed trace; and determining, by searching a database, an application matched with the obtained characteristic parameter as the application matched with the other traces enclosed by the closed trace, wherein the database comprises matching parameters of at least two applications.

In some implementations, the at least one processor is configured to establish the window supported by the application as the window corresponding to the trace complying with the predetermined rule by:

recognizing input contents corresponding to the other traces enclosed by the closed trace, based on the application.

In some implementations, the at least one processor is further configured to display, on the display screen, the recognized input contents to replace a corresponding part of the input traces displayed in real time.

In some implementations, N traces with the predetermined rule are included in the input traces, and the at least one processor is further configured to establish the window corresponding to the trace complying with the predetermined rule by establishing N windows respectively corresponding to the N traces complying with the predetermined rule when the N traces with the predetermined rule are included in the input traces, N being an integer no less than 2.

In some implementations, the at least one processor is further configured to: obtain an user operation on display contents corresponding to the input traces; determine an edit instruction corresponding to the user operation; and perform corresponding editing on the display contents according to the edit instruction.

In some implementations, the input apparatus and the display screen are integrated in an entity, such as a touch-sensitive display screen. In other implementations, the input apparatus is a separate electro-magnetic input screen. The at least one processor is further configured to obtain the user operation via the input area of the electro-magnetic input screen; or obtain the user operation via the touch-sensitive display screen.

In some implementations, the user operation comprises an operation of an edit instruction for copying contents displayed in one window to another window.

One or more technical effects may be achieved by one or more technical solutions in the embodiments of the present disclosure:

1. In the technical solutions according to the embodiment of the present disclosure, input traces input by the operator on the input area are obtained; display contents corresponding to the input traces is displayed on the display screen in real time; it is determined whether a trace complying with a predetermined rule is included in the input traces; when the trace complying with the predetermined rule is included in the input traces, a window corresponding to the trace complying with the predetermined rule is established; and a corresponding relationship is established between the window and the display contents on the display screen which is corresponding to the trace complying with the predetermined rule. As such, when the electronic device confirms the trace complying with the predetermined rule included in the traces input by the user, the window corresponding to the trace complying with the predetermined rule is established, and the corresponding relationship between the display contents on the screen and the window is established, i.e., the display contents being bound to the application corresponding to the window so that the display contents supports the edit format of the application. Thus, when the user needs to edit the display contents, the electronic device may process on the display contents according to the edit format of the application. Therefore, the technical problem with the conventional technical solutions that the processing mode for traces input by the user is generally unitary and inflexible and cannot satisfy requirements of the user may be solved, and the edit requirements of the user on the input traces may be satisfied.

2. In the technical solutions according to the embodiment of the present disclosure, it is determined whether a closed trace is included in the input traces; when the closed trace is included in the input traces, it is determined whether other traces are included in the closed area constituted by the closed trace; when the other traces are included in the closed area constituted by the closed trace, it is determined whether a trace complying with a predetermined rule is included in the input traces. As such, the electronic device is triggered to establish a window only if the closed trace is included in the traces input by the user, and there is content in the closed area enclosed by the closed trace. Therefore, a misoperation of the user causing the electronic device to establish a window the user does not hope to establish may be avoided, so that the approach of establishing the window may better satisfy the requirements of the user.

3. In the technical solutions according to the embodiment of the present disclosure, when N traces complying with the predetermined rule are included in the input traces, N windows respectively corresponding to the N traces complying with the predetermined rule are established, N being an integer no less than 2. As such, when the input traces comprise a plurality of closed traces, and display contents is contained in each of the closed traces, the windows supported by different applications corresponding to different display contents may be established, and various display contents may be bound to the corresponding applications. Thus, different edit requirements of the user on different display contents may be guaranteed.

### Fourth Embodiment

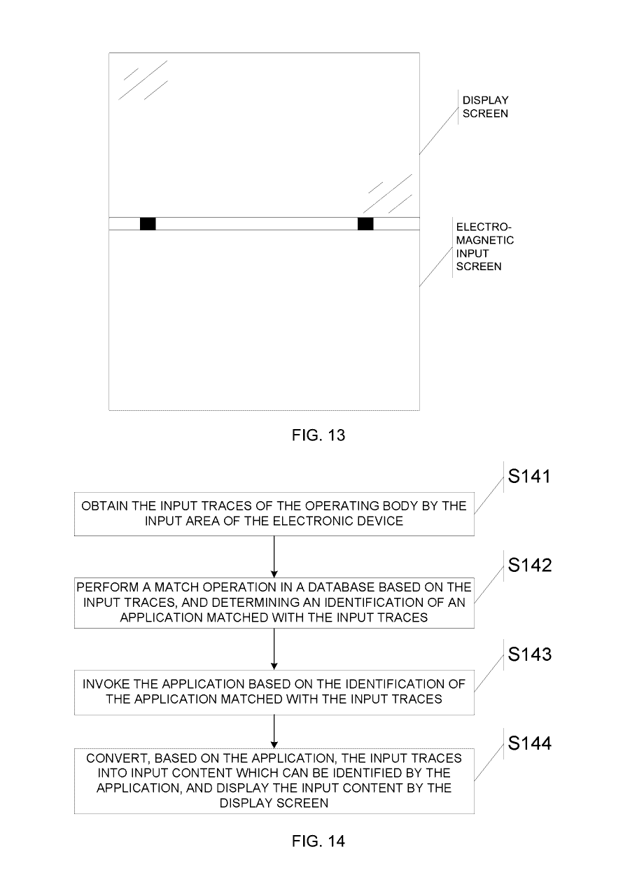

An embodiment of the present disclosure provides an information processing method. FIG. 13 is a schematic diagram of a possible appearance of an electronic device to which the information processing method in the fourth embodiment of the present disclosure may be applied. The electronic device comprises an electro-magnetic input screen and a display screen. An area on the electro-magnetic input screen in which the input operation of the operator may be detected is an input area. The electro-magnetic input screen and the display screen are arranged on different positions, and thus the input area is not overlapped with the display screen. The operator may be a finger, a palm or an electro-magnetic pen etc. of the user, which is not limited by the present disclosure. In particular implementations, when the user inputs by the operator in the input area, he may input directly in the input area, or may place one or more pieces of paper on the input area so that when he writes on the paper in the top layer, the input traces may be detected by the electro-magnetic input screen, and at the same time, his chirography may be seen intuitively from the paper.

Hereinafter, a flowchart of the information processing method in the embodiment of the present disclosure will be described with reference to FIG. 14. As shown in FIG. 14, the method comprises:

step S141 of obtaining the input traces of the operator by the input area of the electronic device;

step S142 of performing a match operation in a database based on the input traces, and determining an identification of an application matched with the input traces;

step S143 of invoking the application based on the identification of the application matched with the input traces;

step S144 of converting, based on the application, the input traces into input contents which can be recognized by the application, and displaying the input contents by the display screen.

Particularly, before step S141, the electronic device may run one or more applications, or may not run any application, which may be set by the skilled in the art according to actual requirements, and may not be limited by the present disclosure.

In step S141, the input traces of the operator are obtained by the electronic device in the input area. Then in step S142, the electronic device performs the match operation in the database according to the obtained input traces.

Specifically, matching parameters and identifications of at least two applications are stored in the database, and the matching parameters of each application correspond to the identification of the application. On one hand, the matching parameters of the application may be parameters of an input object which may be recognized by the application. For example, the matching parameters of a word processing application may be a Chinese word matching parameter, an English word matching parameter etc., and the matching parameters of an electronic table application may be a number matching parameter, a table matching parameter etc. On the other hand, the identification of the application in the embodiments of the present disclosure includes, but not limited to, an icon, a name, a code name or a port serial number etc. of the application, which may be selected by the skilled in the art according to the actual requirements, and are not limited by the present disclosure. Hereinafter, an example will be illustrated in which the identification of the application is the name of the application for convenience of illustration.

After the identification of the application matched with the input traces is determined, step S143 is performed, in which the application is invoked based on the identification of the application matched with the input traces.

After the application is invoked, step S144 is performed. The application recognizes the input traces, so that the irregular input traces may be recognized as regular input traces which can be recognized by the application. And, the input contents is displayed on the display screen.

For example, it is assumed that the input traces input by the operator of the user in the input area are displayed as shown in FIG. 15A. The electronic device performs the match operation in the database on the input traces in FIG. 15A, and then determines that the identification of the application corresponding to the input traces is a name of “electronic table”. Thus, the electronic device invokes the electronic table application according to the matched result of the name “electronic table”, and transmits the input traces to the electronic table application to be identified. The electronic table application reads the input traces, recognizes the input traces according to the parameters which can be recognized by the electronic table application, and finally recognizes the input traces as the electronic table as shown in FIG. 15B.

Hereinafter, step S142 of determining the identification of the application matched with the input traces will be described in detail. In an embodiment of the present disclosure, step S142 comprises:

obtaining a characteristic parameter of the input traces;

determining, among the matching parameters of at least two applications, the matching parameters of a first application matched with the characteristic parameter;

using the identification corresponding to the first application as the identification of the application matched with the input traces, and determining that the first application is the application capable of identifying the input traces.

In particular, the electronic device firstly extracts the characteristic parameter of the input traces. In the embodiments of the present disclosure, the characteristic parameters of the input traces may comprise, but not limited to, a start point, an end point, an inflection point, a writing order and a trace outline etc. of the input traces. Then, the matching parameters which are matched with the characteristic parameters may be determined by matching the characteristic parameters of the input traces with the matching parameters of at least two applications, the first application corresponding to the matching parameters may be used as the application matched with the input traces, and the identification of the first application may be used as the identification of the application.

Hereinafter, several examples are introduced for illustrating the implementations of step S142. The implementations of step S142 may include, but not limited to, the following examples.

In a first example, it is assumed that the input traces are displayed as shown in FIG. 15A. The characteristic parameters of the input traces extracted by the electronic device are an outline, 4 inflection points and 12 cross points of the input traces. And it is assumed that the matching parameters of the electronic table application include: a degree of approximation between the outline and a rectangle being higher than 85%, 4 inflection points, and all of cross points being located on a horizontal line and a vertical line or an approximately horizontal line and an approximately vertical line. By comparison, the electronic device may determine that the outline of the input traces in FIG. 15A is approximate to a rectangle, and the degree of approximation is 90%; there are 4 inflection points; and every 3 cross points, among 12 cross points, are located on an approximately horizontal line. Further, the electronic device may determine that the characteristic parameters are matched with the matching parameters of an electronic table application. Thus, the first application is the electronic table application, and the identification name “electronic table” of the electronic table application is the identification of the application matched with the input traces.

In a second example, it is assumed that the input traces are displayed as shown in FIG. 16A. The characteristic parameters of the input traces extracted by the electronic device are an outline of a plurality of linear traces, and 3 cross points. And it is assumed that the matching parameters of the electronic table application include: an approximately horizontal line, and an end point of the approximately horizontal line and two oblique lines constituting an arrow; an approximately vertical line, and an end point of the approximately vertical line and two oblique lines constituting an arrow; the approximately horizontal line and the approximately vertical line having one and only one cross point. By comparison, the electronic device may determine that the input traces in FIG. 16A has an approximately horizontal line, an approximately vertical line, and there is only one cross point between the two lines; and also, the end point of each of the two lines constitutes an arrow together with two oblique lines. Therefore, the electronic device may determine that the characteristic parameters are matched with the matching parameters of an electronic table application. Thus, the first application is the electronic table application, and the identification name “electronic table” of the electronic table application is the identification of the application matched with the input traces.

In a third example, it is assumed that the input traces are displayed as shown in FIG. 17A. The characteristic parameters of the input traces extracted by the electronic device are an outline, and cross points of the input traces. The electronic device may determine that the characteristic parameters are matched with the Chinese word parameters by comparing the characteristic parameters with the matching parameters in the database. Therefore, the electronic device may determine that the characteristic parameters are matched with the matching parameters of a word processing application. Thus, the first application is the word processing application, and the identification name “handwriting input method” of the word processing application is the identification of the application matched with the input traces.

More examples are omitted here. Next in step S143, the application is invoked according to the application identification determined in step S142. For example, if the determined identification is the name “electronic table”, the electronic table application will be invoked.

Then, the electronic device provides the input traces to the application, so that the application may convert the input traces into the input contents which can be recognized by the application. In particular, the conversion of the input traces by the application may be performed according to the content which can be recognized by the application. For example, the electronic table application can recognize a table, a number, a coordinate chart, then the input contents into which the electronic table is converted may be one or more combinations of table, number or coordinate chart.

With reference to the three examples as previously discussed, in the first example, the electronic table application may convert the 4 approximately horizontal lines in the input traces as shown in FIG. 15A into horizontal lines, convert the 3 approximately vertical lines into vertical lines, and thus convert the outline of the input traces from an approximate rectangle into a rectangle. Further, the numbers in the table which are written by hand are converted into standard Arabic numbers. After the conversion, input contents may be obtained as shown in FIG. 15B.

In the second example, the electronic table application may convert the approximately horizontal line in the input traces as shown in FIG. 16A into a horizontal line, and convert the arrow constituted by the end point of the approximately horizontal line and the two oblique lines into a standard arrow; convert the approximately vertical line into a vertical line, and convert the arrow constituted by the end point of the approximately vertical line and the two oblique lines into a standard arrow; and convert a function image in the coordinate chart from the approximate straight lines into straight lines. Finally, input contents as shown in FIG. 16B is obtained.

In the third example, the handwriting input method may convert the 4 Chinese words written by hand into standard Chinese words to obtain input contents as shown in FIG. 17B.

After the application converts the input trace into the input content, in step S144, the input contents may be displayed on the display screen to facilitate the user's viewing. Further, the electronic device may save the input content, or may automatically add the input contents to the desktop etc., which are not limited by the present disclosure.

By the above description, in the embodiments of the present disclosure, the electronic device performs the match operation in the database based on the input traces, determines the identification of the matched application, then invokes the application corresponding to the identification of the application, so that the application may convert the input traces into the input contents which can be recognized by the application. Therefore in the embodiments of the present disclosure, identifying the input traces is not limited to the application currently running in the electronic device. For example, if the currently running application is a music player, it may still recognize the words input by the user. The input traces may be recognized even when the electronic device has not run the application.

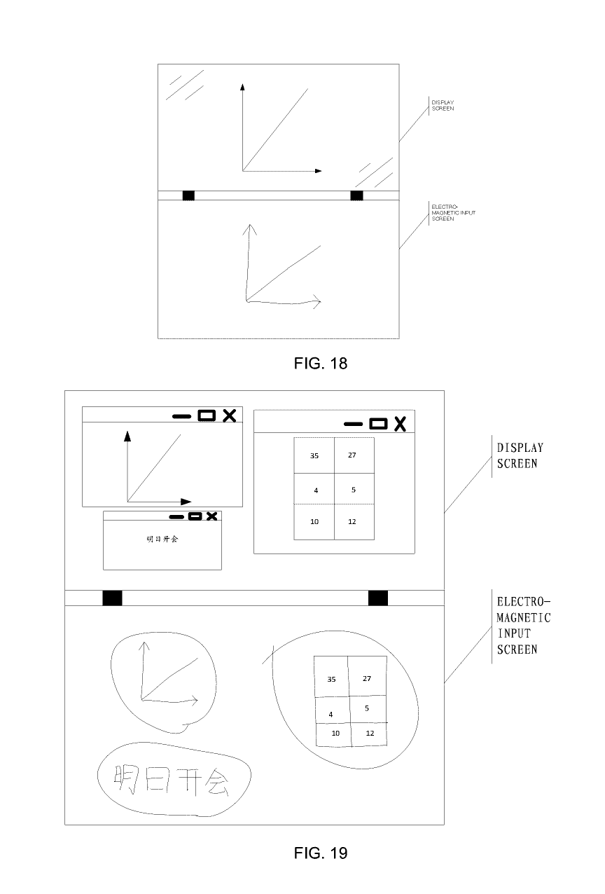

Hereinafter, an example will be described in order to better understand the above technical solution. The user needs to record for a convention on the electronic device in the embodiment of the present disclosure during the convention. When the convention begins, there is no application running in the electronic device. It is assumed that the user places a piece of paper on the input area, and uses an electro-magnetic pen provided with a normal pen refill for recording in the input area during the convention. Since the normal pen refill is provided in the electro-magnetic pen, the user may view notes that he left on the paper, as shown in FIG. 15A. The input traces consistent with the notes in FIG. 15A may be obtained by cooperation of the input area and the electro-magnetic pen. The electronic device performs the match operation in the database, determines that the identification of the application matched with the input traces is the name “electronic table”, and then invokes the electronic table application. After the electronic table application is launched, the input traces may be identified, then the input contents as shown in FIG. 15B may be obtained, and the input contents may be displayed on the display screen, as shown in FIG. 18.

Therefore, when the convention is over, the notes of the user on the paper have been displayed by the electronic device on the display screen in formats that can be recognized by respective applications. Even if the user does not have enough time during the convention to timely launch the application capable of identifying the input traces according to the content needed to be recorded, the electronic device in the embodiments of the present disclosure may still automatically invoke the application for identifying the input traces.

Further in the embodiments of the present disclosure, in order to facilitate the user to edit the input object after the input object is displayed on the display screen, step S144 comprises:

displaying the input contents matched with the input traces on the display screen.

The method further comprises:

controlling a plurality of edit identifications of the application to be in a non-display state, wherein each edit identification corresponds to at least one edit instruction, and the edit instruction can perform an edit operation on the input content;

obtaining, by the input area, a specific operation of editing the input contents which is performed for the input content;

determining, among the plurality of edit identifications in the non-display state, a specific edit identification corresponding to the specific operation;

performing the at least one edit instruction corresponding to the specific edit identification, so as to perform specific editing on the input content.

Firstly, the input contents matched with the input traces is displayed in the display screen. Specifically in the embodiments of the present disclosure, displaying the input contents matched with the input traces particularly comprises: displaying only the input contents converted according to the input trace. For example, if the application is the electronic table application and assuming that the input traces are displayed as shown in FIG. 15A, the displayed input contents is displayed as shown in FIG. 15B, and the table after the fourth row and the third column will not be displayed.

Further, the electronic device will control the plurality of edit identifications of the application to be in the non-display state. Specifically in the embodiments of the present disclosure, each of edit identifications corresponds to at least one edit instruction, and the edit instruction can perform the edit operation on the input contents. For example, the application is an electronic table application, and the plurality of edit identifications are edit identifications in the electronic table application, e.g. an automatic summation identification, a screening identification, an ordering identification etc. The automatic summation identification corresponds to an instruction of reading data, a summation instruction, and an instruction of displaying a summation result; the screening instruction corresponds to an instruction of reading data, a comparison instruction, and an instruction of displaying a summation result etc.

Next, the electronic device obtains, by the input area, the specific operation of editing the input contents which is performed for the input content. Specifically in the embodiments of the present disclosure, the specific operation is an operation corresponding to the plurality of edit identifications, which is an operation of editing the input contents performed by the operator of the user. For example, the specific operation may be clicking a plurality of numbers in the table, and then the corresponding edit identification may be the automatic summation identification; the specific operation may be sliding from the first table on some row or some column to the last table on that row or that column, and then the corresponding edit identification may be the ordering identification, which may be set by the skilled in the art according to actual requirements, and are not limited by the present disclosure. The corresponding relationship between the specific operation and the corresponding edit identification may be informed to the user in advance, so as to be known by the user.

After the user performs the specific operation by the operator, the electronic device may further determine the specific edit identification corresponding to the specific operation, then perform at least one edit instruction corresponding to the specific edit identification, so as to edit input contents.

Following the example as previously described, it is assumed that the user needs to edit the table as shown in FIG. 15B after the convention is over. The user clicks the numbers in respective blocks on the first column of the table sequentially, and then the specific operation obtained by the electronic device is clicking the numbers in respective blocks on the first column of the table sequentially. Assuming that the user clicks a plurality of numbers in the table, and the corresponding edit identification is the automatic summation identification, the electronic device may determine that the edit identification in the non-display state corresponding to the specific operation performed by the operator is the automatic summation identification; then the electronic device performs the instruction of reading data, the summation instruction and the instruction of displaying the summation result corresponding to the automatic summation identification. Thus, the electronic device may read every numbers on the first column of the table, sum 35, 4 and 10 up to obtain the summation result 49, and display the summation result.

According to the technical solution of the embodiments of the present disclosure, after the input traces are converted into the input contents which can be recognized by the application and the input contents is displayed, the input contents may be recognized further according to the specific operation, so that the user operation is more convenient.

Alternatively in the embodiments of the present disclosure, in order to facilitate the user to edit different input contents in different windows, the method may further comprise:

determining whether a trace complying with the predetermined rule is included in the input traces to obtain the determination result;

establishing a window according to the trace complying with the predetermined rule, when the determination result indicates that the trace complying with the predetermined rule is included in the input traces;

establishing a corresponding relationship between the window and the input contents and a corresponding relationship between the window and the application, based on the window;

running the application in the window, and displaying in the window the input content, so that the application may edit input contents in the window.

In particular, the electronic device determines whether the trace complying with the predetermined rule is included in the input traces. In the embodiments of the present disclosure, determining whether the trace complying with the predetermined rule is included in the input traces to obtain the determination result comprises:

determining whether a closed trace is included in the input trace to obtain a first determination result;

determining whether the remaining traces in the input traces are included in the closed area constituted by the closed trace when the first determination result indicates that the closed trace is included in the input trace to obtain a second determination result;

determining that the determination result is “Yes”, indicating that the trace complying with the predetermined rule is included in the input traces, when the second determination result indicates that the remaining traces in the input traces are included in the closed area constituted by the closed trace.

Specifically in the embodiments of the present disclosure, the electronic device obtains the input traces input by the operator in the input area, and then recognizes whether there is a closed trace in the input traces. When the closed trace is identified, the first determination result is “Yes”. Further, the electronic device recognizes whether there is other trace in the closed area enclosed by the closed trace. When there are other traces of the input traces in the closed area, the second determination result is “Yes”. When the second determination result is “Yes”, indicating that the input traces includes the closed trace, and the closed trace further includes the other traces. Thus, the determination result “Yes” is obtained.

For convenience of illustration, a specific example will be described below. Assuming that the user makes convention records during the convention, the content recorded on the paper placed on the input area by the user using the pen with the normal pen refill is shown in FIG. 19. The electronic device obtains the input traces which are consistent with the chirography on the paper, while the user records on the paper.

The electronic device recognizes the input traces, and determines that there are three closed traces in the input traces. Thus, the first determination result is “Yes”. Further, it is further recognized in the closed areas respectively enclosed by the three closed traces that there are other traces respectively in the three closed areas. Thus, the second determination result is “Yes”. Therefore, in a case that the second determination result is “Yes”, the determination result is “Yes”, i.e., the traces complying with the predetermined rule being included in the input traces.

Next, when the determination result is “Yes”, the electronic device establishes windows according to the traces complying with the predetermined rule, specifically, establishes windows the number of which is identical with the number of the traces complying with the predetermined rule. In particular implementations, the skilled in the art may set a center of the window to be located at a center of the corresponding trace complying with the predetermined rule, and/or may set a size of the window is identical with that of the corresponding closed area, which are not limited by the present disclosure.

And, the electronic device matches and recognizes the input traces according to the method as previously described, so as to obtain the input contents which can be recognized by the application. Further, the electronic device establishes the corresponding relationship between the window and the input content, and the corresponding relationship between the window and the application.

Specifically in the embodiments of the present disclosure, the corresponding relationships between the window and the input content, the application comprise: the application matched with the input trace in the closed area running in the window which is established according to the closed area, and the input contents which is converted by the application from the input traces also displaying in the window.

Finally, the application runs in the window, and the input contents converted from the input traces are displayed so that the user may edit input contents in the window.

Following the example as previously described with reference to FIG. 19, it is assumed that the input traces included in the first closed trace may be similar to a table. The first window is established according to the first closed area, the electronic table application will run in the window corresponding to the first closed area, and a standard table converted from the input traces similar to the table will be displayed in the first window. The input traces included in the second closed trace may be similar to a coordinate chart. The second window is established according to the second closed area, the electronic table application will run in the window corresponding to the second closed area, and a standard coordinate chart converted from the input traces similar to the coordinate chart will be displayed in the second window. The input traces included in the third closed trace may be similar to Chinese words. The third window is established according to the third closed area, the handwriting word processing application will run in the window corresponding to the third closed area, and standard Chinese words converted from the input traces similar to the Chinese words will be displayed in the third window. Finally, the content as shown in FIG. 19 may be displayed on the display screen.

### Fifth Embodiment

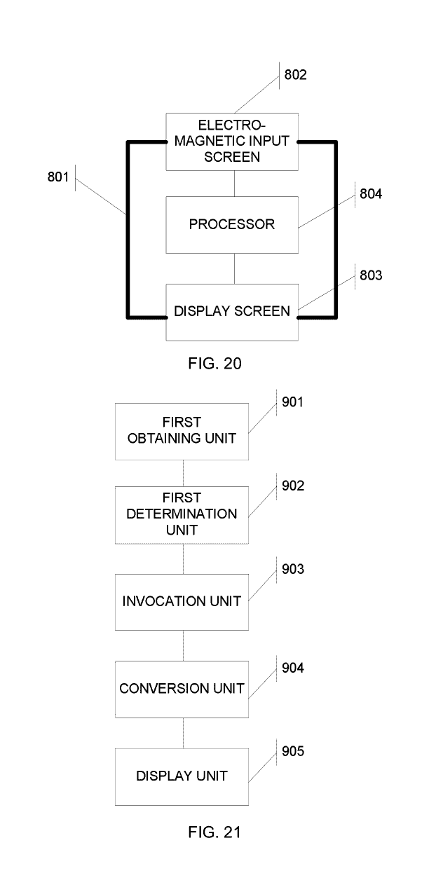

An embodiment of the present disclosure provides an electronic device. With reference to FIG. 20, the electronic device comprises:

a housing 801;

an electro-magnetic input screen 802 arranged on a surface of the housing, and configured to obtain input traces input by the operator in an input area of the electro-magnetic input screen, the input area being not overlapped with a display screen 803 of the electronic device;

a processor 804 arranged in the housing and connected to the electro-magnetic input screen, configured to match in a database based on the input traces, determine an identification of an application matched with the input traces, the database including matching parameters and identifications of at least two applications; invoke the application based on the identification of the application matched with the input traces; and convert the input traces into input contents which can be recognized by the application, based on the application;

the display screen 803 arranged on the surface of the housing and connected to the processor, configured to display the input content.

Specifically, when the processor 804 determines the identification of the application matched with the input traces, the processor 804 obtains characteristic parameters of the input traces; determines, among the matching parameters of at least two applications, the matching parameter of the first application matched with the characteristic parameters; uses the identification corresponding to the first application as the identification of the application matched with the input traces, and determines that the first application is the application capable of identifying the input traces.

Specifically, the display screen 803 is configured to display the input contents matched with the input trace.

Further, the processor 804 is configured to control a plurality of edit identifications of the application to be in the non-display state, wherein each of edit identifications corresponds to at least one edit instruction, and the edit instruction can perform the edit operation on the input content.

The electro-magnetic screen 802 is further configured to obtain, by the input area, the specific operation of editing the input contents which is performed for the input content.

The processor 804 is further configured to determine, among the plurality of edit identifications in the non-display state, the specific edit identification corresponding to the specific operation; and perform at least one edit instruction corresponding to the specific edit identification, so as to edit input contents.

Alternatively, the processor 804 is further configured to determine whether the trace complying with the predetermined rule is included in the input traces to obtain a determination result; establish a window according to the trace complying with the predetermined rule when the determination result indicates that the trace complying with the predetermined rule is included in the input traces; establish a corresponding relationship between the window and the input content, and a corresponding relationship between the window and the application, based on the window; and run the application in the window.

The display screen 806 is further configured to display the input contents in the window.

Specifically, the processor 804 may particularly be a general central processing unit (CPU), or an application specific integrated circuit (ASIC), or one or more integrated circuits for controlling execution of program.

Further, the electronic device may further comprise a storage. There may be one or more storages. The storage may comprise a read only memory (ROM), a random access memory (RAM) and a magnetic disc memory.

Various variations and particular embodiments of the information processing method according to the embodiments of FIGS. 12-19 as previously discussed also can be applied to the electronic device of the present embodiment. By the above description of the information processing method, the skilled in the art may clearly understand the implementation of the electronic device in the present embodiment. Thus, the description thereof will be omitted here for simplicity.

### Sixth Embodiment

Based on the principle of the present disclosure identical with the information processing method in the first embodiment, an embodiment of the present disclosure provides an electronic device. As shown in FIG. 21, the electronic device comprises:

a first obtaining unit 901, configured to obtain input traces of an operator by an input area of the electronic device, the input area being not overlapped with a display screen of the electronic device;

a first determination unit 902, configured to match in a database based on the input traces, determine an identification of an application matched with the input traces, the database comprising matching parameters and identifications of at least two applications;

an invocation unit 903, configured to invoke the application based on the identification of the application matched with the input traces;

a conversion unit 904, configured to convert, by the application, the input traces into input contents which can be recognized by the application;

a display unit 905, configured to display the input contents by the display screen.

Specifically, the first determination unit 902 is configured to obtain characteristic parameters of the input traces; determine, among the at least matching parameters of the application, matching parameters of the first application matched with the characteristic parameters; use an identification corresponding to the first application as the identification of the application matched with the input traces; and determine that the first application is the application capable of identifying the input traces.

When the display unit 905 displays the input content, the display unit 905 is configured to display the input contents matched with the input traces by the display screen.

Further, the electronic device of the embodiments of the present disclosure may comprise:

a control unit, configured to control a plurality of edit identifications of the application to be in a non-display state, wherein each edit identification corresponds to at least one edit instruction, and the edit instruction can perform an edit operation on the input content;

the first obtaining unit 901 being further configured to obtain, by the input area, a specific operation of editing the input contents which is performed for the input content.

The electronic device further comprises a second determination unit, configured to determine, among the plurality of edit identifications in the non-display state, a specific edit identification corresponding to the specific operation.

The electronic device further comprises a performing unit, configured to perform the at least one edit instruction corresponding to the specific edit identification, so as to perform specific editing on the input content.

Further, the electronic device of the embodiments of the present disclosure may comprises:

a determination unit, configured to determine whether a trace complying with the predetermined rule is included in the input traces to obtain a determination result;

a first establishment unit, configured to establish a window according to the trace complying with the predetermined rule, when the determination result indicates that the trace complying with the predetermined rule is included in the input traces;

a second establishment unit, configured to establish a corresponding relationship between the window and the input contents and a corresponding relationship between the window and the application, based on the window;

a running unit, configured to run the application in the window, and displaying in the window the input content, so that the application may edit input contents in the window.

Various variations and particular embodiments of the information processing method according to the embodiments of FIGS. 13-19 as previously discussed also can be applied to the electronic device of the present embodiment. By the above description of the information processing method, the skilled in the art may clearly understand the implementation of the electronic device in the present embodiment. Thus, the description thereof will be omitted here for simplicity.

One or more technical effects may be achieved by one or more technical solutions in the embodiments of the present disclosure:

In the technical solutions according to the embodiment of the present disclosure, input traces of the operator are obtained on the input area of the electronic device, the input area being not overlapped with the display screen of the electronic device; the match operation is performed in the database based on the input traces, and the identification of the application matched with the input traces is determined, the database comprising matching parameters and identifications of at least two applications; the application is invoked based on the identification of the application matched with the input traces; the input traces are converted by the application into input contents which can be recognized by the application, and the input contents is displayed on the display screen. Therefore in the embodiments of the present disclosure, the electronic device performs the match operation in the database based on the input traces, determines the identification of the matched application, then invokes the application corresponding to the identification of the application, so that the application may convert the input traces into the input contents which can be recognized by the application. Therefore in the embodiments of the present disclosure, identifying the input traces is not limited to the application currently running in the electronic device. For example, if the currently running application is a music player, it may still recognize the words input by the user. The input traces may be recognized even when the electronic device has not run the application.

It can be appreciated by those skilled in the art that the embodiments of the present disclosure can be implemented as a method, a system or a computer program product. The present disclosure may include pure hardware embodiments, pure software embodiments and any combination thereof. Also, the present disclosure may include a computer program product implemented on one or more computer readable storage medium (including, but not limited to, magnetic disk storage, CD-ROM, optical storage) containing computer readable program codes.

The present disclosure have been described with reference to the flowcharts and/or block diagrams of the method, device (system) and computer program product according to the embodiments of the present disclosure. It can be appreciated that each process and/or block in the flowcharts and/or block diagrams, or any combination thereof, can be implemented by computer program instructions. Such computer program instructions can be provided to a general computer, a dedicated computer, an embedded processor or a processor of any other programmable data processing device to constitute a machine, such that the instructions executed by the computer or the processor of any other programmable data processing device can constitute means for implementing the functions specified by one or more processes in the flowcharts and/or one or more blocks in the block diagrams.

These computer program instructions can also be stored in a computer readable memory that can direct a computer or any other programmable data processing device to operate in a particular way. Thus, the instructions stored in the computer readable memory constitute an article of manufacture including instruction means for implementing the functions specified by one or more processes in the flowcharts and/or one or more blocks in the block diagrams.

These computer program instructions can also be loaded onto a computer or any other programmable data processing device, such that the computer or the programmable data processing device can perform a series of operations/steps to achieve a computer-implemented process. In this way, the instructions executed on the computer or the programmable data processing device can provide steps for implementing the functions specified by one or more processes in the flowcharts and/or one or more blocks in the block diagrams.

Particularly, the computer program instructions corresponding to the information processing method in the embodiments of the present disclosure may be stored in a storage medium such as an optic disk, a hard disk, a U-disk etc., the computer program instructions comprising:

instructions for obtaining input traces, which are input by an operator, on an input area of an electronic device, the input area being not overlapped with a display area of a display screen of the electronic device;

instructions for displaying the input traces on the display screen in real time;

instructions for determining whether a trace complying with a predetermined rule is included in the input traces; and

instructions for establishing a window corresponding to the trace complying with the predetermined rule when the trace complying with the predetermined rule is included in the input traces, the window being associated with an application.

Alternatively, the trace complying with the predetermined rule is a closed trace enclosing other traces.

Alternatively, the instructions for establishing the window corresponding to the trace complying with the predetermined rule when the trace complying with the predetermined rule is included in the input traces comprises:

instructions for determining an application matched with the other traces enclosed by the closed trace; and

instructions for establishing a window supported by the application as the window corresponding to the trace complying with the predetermined rule.

Alternatively, the instructions for determining the application matched with the other traces enclosed by the closed trace comprises:

instructions for obtaining a characteristic parameter of the other traces enclosed by the closed trace;

instructions for determining, by searching a database, an application matched with the obtained characteristic parameter as the application matched with the other traces enclosed by the closed trace, wherein the database comprises matching parameters of at least two applications.

Alternatively, the instructions for establishing the window supported by the application as the window corresponding to the trace complying with the predetermined rule comprises:

instructions for recognizing input contents corresponding to the other traces enclosed by the closed trace, based on the application.

Alternatively, the computer program instructions further comprise:

instructions for displaying, on the display screen, the recognized input contents to replace a corresponding part of the input traces displayed in real time.

Alternatively, the instructions for establishing the window corresponding to the trace complying with the predetermined rule when the trace complying with the predetermined rule is included in the input traces comprises:

instructions for establishing N windows respectively corresponding to N traces complying with the predetermined rule when the N traces complying with the predetermined rule are included in the input traces, N being an integer no less than 2.

Alternatively, the computer program instructions further comprise:

instructions for obtaining an user operation on display contents corresponding to the input traces;

instructions for determining an edit instruction corresponding to the user operation; and

instructions for performing corresponding editing on the display contents according to the edit instruction.

Alternatively, the instructions for obtaining the user operation on the display contents corresponding to the input traces comprises:

instructions for obtaining the user operation via the input area; or

instructions for obtaining the user operation via a touch-sensitive display screen.

Alternatively, the user operation comprises an operation of an edit instruction for copying contents displayed in one window to another window.

Although preferred embodiments of the present disclosure have been described, the skilled in the art may make additional variations and modifications on these embodiments once he knows the basic inventive concept. Therefore, the appended claims intend to be explained as including the preferred embodiments and all of variations and modifications falling into the scope of the present disclosure.

Obviously, various modifications and variants can be made to the present disclosure by those skilled in the art without departing from the spirit and scope of the present disclosure. Therefore, these modifications and variants are to be encompassed by the present disclosure if they fall within the scope of the present disclosure as defined by the claims and their equivalents.

I/We claim:

1. An information processing method, comprising:
obtaining input traces, which are input by an operator, on an input area of an electronic device, the input area being not overlapped with a display area of a display screen of the electronic device;
displaying the input traces on the display screen in real time;
determining whether a trace complying with a predetermined rule is included in the input traces; and
establishing a window corresponding to the trace complying with the predetermined rule when the trace complying with the predetermined rule is included in the input traces, the window being associated with an application.

2. The method of claim 1, wherein the trace complying with the predetermined rule is a closed trace enclosing other traces.

3. The method of claim 2, wherein establishing the window corresponding to the trace complying with the predetermined rule when the trace complying with the predetermined rule is included in the input traces comprises:
determining an application matched with the other traces enclosed by the closed trace; and
establishing a window supported by the application as the window corresponding to the trace complying with the predetermined rule.

4. The method of claim 3, wherein determining the application matched with the other traces enclosed by the closed trace comprises:
obtaining a characteristic parameter of the other traces enclosed by the closed trace;
determining, by searching a database, an application matched with the obtained characteristic parameter as the application matched with the other traces enclosed by the closed trace, wherein the database comprises matching parameters of at least two applications

5. The method of claim 3, wherein establishing the window supported by the application as the window corresponding to the trace complying with the predetermined rule comprises:
recognizing input contents corresponding to the other traces enclosed by the closed trace, based on the application.

6. The method of claim 5, further comprising:
displaying, on the display screen, the recognized input contents to replace a corresponding part of the input traces displayed in real time.

7. The method of claim 1, wherein establishing the window corresponding to the trace complying with the predetermined rule when the trace complying with the predetermined rule is included in the input traces comprises:
establishing N windows respectively corresponding to N traces complying with the predetermined rule when the N traces complying with the predetermined rule are included in the input traces, N being an integer no less than 2.

8. The method of claim 6, further comprising:
obtaining an user operation on display contents corresponding to the input traces;
determining an edit instruction corresponding to the user operation; and
performing corresponding editing on the display contents according to the edit instruction.

9. The method of claim 8, wherein obtaining the user operation on the display contents corresponding to the input traces comprises:
obtaining the user operation via the input area; or
obtaining the user operation via a touch-sensitive display screen.

10. The method of claim 8, wherein the user operation comprises an operation of an edit instruction for copying contents displayed in one window to another window.

11. An electronic device, comprising:
a housing;
a display screen arranged on the housing;
an input apparatus arranged on a surface of the housing, an input area of the input apparatus being not overlapped with a display area of the display screen;
a storage arranged in the housing and configured to store program instructions;
at least one processor arranged in the housing, when the program instructions are executed on the at least one processor, the at least one processor being configured for:
obtaining input traces, which are input by an operator, on the input area of the input apparatus;
displaying the input traces on the display screen in real time;
determining whether a trace complying with a predetermined rule is included in the input traces; and
establishing a window corresponding to the trace complying with the predetermined rule when the trace complying with the predetermined rule is included in the input traces, the window being associated with an application.

12. The electronic device of claim 11, wherein the trace complying with the predetermined rule is a closed trace enclosing other traces.

13. The electronic device of claim 12, wherein establishing the window corresponding to the trace complying with the predetermined rule when the trace complying with the predetermined rule is included in the input traces comprises:
determining an application matched with the other traces enclosed by the closed trace; and
establishing a window supported by the application as the window corresponding to the trace complying with the predetermined rule.

14. The electronic device of claim 13, wherein determining the application matched with the other traces enclosed by the closed trace comprises:
obtaining a characteristic parameter of the other traces enclosed by the closed trace; and
determining, by searching a database, an application matched with the obtained characteristic parameter as the application matched with the other traces enclosed by the closed trace, wherein the database comprises matching parameters of at least two applications.

15. The electronic device of claim 13, wherein establishing the window supported by the application as the window corresponding to the trace complying with the predetermined rule comprises:
recognizing input contents corresponding to the other traces enclosed by the closed trace, based on the application.

16. The electronic device of claim 15, wherein the at least one processor is further configured to display, on the display screen, the recognized input contents to replace a corresponding part of the input traces displayed in real time.

17. The electronic device of claim 11, wherein establishing the window corresponding to the trace complying with the predetermined rule when the trace complying with the predetermined rule is included in the input traces comprises:
establishing N windows respectively corresponding to N traces complying with the predetermined rule when the N traces complying with the predetermined rule are included in the input traces, N being an integer no less than 2.

18. The electronic device of claim 16, wherein the at least one processor is further configured to:
obtain an user operation on display contents corresponding to the input traces;
determine an edit instruction corresponding to the user operation; and
perform corresponding editing on the display contents according to the edit instruction.

19. The electronic device of claim 18, wherein the input apparatus comprises a touch-sensitive display screen or an electro-magnetic input screen, and obtaining the user operation on the display contents corresponding to the input traces comprises:
obtaining the user operation via the input area of the electro-magnetic input screen; or
obtaining the user operation via the touch-sensitive display screen.

20. The electronic device of claim 18, wherein the user operation comprises an operation of an edit instruction for copying contents displayed in one window to another window.
